(19) United States
(12) Patent Application Publication
(10) Pub. No.: US 2011/0040608 A1
(43) Pub. Date: Feb. 17, 2011

(54) Methods and Systems for an Improved Rewards Program

(76) Inventors: Ruven Cohen, New York, NY (US); Michael Biafore, Newton, CT (US); Jeff Shaffer, Larchmont, NY (US); Patricia Asgeirsson, Bayville, NY (US); Edward Ebel, Chesterfield, VA (US)

Correspondence Address: BAKER BOTTS L.L.P., 30 ROCKEFELLER PLAZA, 44TH FLOOR, NEW YORK, NY, 10112-4498, US

(21) Appl. No.: 12/532,698

(22) PCT Filed: Mar. 24, 2008
(86) PCT No.: PCT/US08/58007

§ 371 Date: Oct. 12, 2010

Related U.S. Application Data
(60) Provisional application No. 60/896,639, filed on Mar. 23, 2007.

(51) Int. Cl. G06Q 30/00; G06Q 90/00

(52) U.S. Cl. 705/14.17; 705/500; 705/14.1

(57) ABSTRACT

Systems and methods encourage customer loyalty by providing an enhanced rewards program. A customer with an account with an account provider may receive a reward (e.g., cash back) for activity with respect to the account. To encourage loyalty, the customer may be asked whether they wish to save the reward, and the saved reward may be enhanced based at least in part on subsequent activity with respect to the account (e.g., maintaining the account in good standing for a predetermined time). The customer may be awarded the enhanced reward once the conditions of the subsequent activity have been satisfied. In one example embodiment, a customer may receive cash back as a reward for a purchase. As an incentive to remain with the financial institution, the customer may decline to redeem the cash back, and the cash back amount may increase by a multiple after a predetermined time.

### RELATED APPLICATION

This application claims priority to U.S. provisional patent application 60/896,639, entitled Method And System For An Improved Rewards Program Using A Payment Card Or Device and filed Mar. 23, 2007, which is incorporated by reference herein.

### BACKGROUND

Rewards programs have become popular with account providers looking to maintain customer loyalty. Customers are lured by the accrual of rewards for their continued activity with the account provider. Often, but not exclusively, rewards may increase as activity with the account provider increases.

Rewards programs come in various forms and include various rules. For example, in one common type of program, participants earn cash back for purchases made with the account provider (e.g., a credit card). The cash back may be proportional to the amount spent. In other programs, redeemable points may be awarded instead of cash back. In other programs, certain types of purchases earn greater rewards than other types of purchases.

In some programs, the rewards remain active indefinitely, while in other programs, the rewards expire once the participant is no longer associated with the account provider. In other programs, rewards regularly expire, for example, after a certain amount of time following the issuance of the reward.

In some programs, merchandise and other goods and services may be awarded in addition to, or instead of, cash back. In some programs, a reward may be provided by a separate organization. For example, purchases with one organization may earn the participant airline miles with another organization.

### SUMMARY

Methods and Systems for an Improved Rewards Program are described herein.

Some embodiments include a method of operating a rewards program including awarding an initial reward to a customer based on customer activity with respect to a customer account, said initial reward including initial terms of said initial reward; saving said initial reward; enhancing said saved reward based at least in part on subsequent customer activity with respect to said customer account; and distributing said enhanced reward to said customer, wherein enhancing said saved reward includes improving said saved reward beyond said initial terms of said initial reward. Said initial reward can include cash back, said subsequent customer activity can include maintaining said customer account in good standing for a predetermined time, and enhancing said saved reward can include increasing said cash back by a percentage of said cash back. Said initial reward can include at least one of reward points, cash back, statement credit, an amount redeemable for other goods or services, goods, services, or any combination thereof. Said customer account can be associated with a payment card account. Said payment card can be a credit card, debit card, or stored value card. Said rewards program can be associated with an airline frequent flier program. Said customer activity can include at least one of making a purchase using said customer account, joining said rewards program, embarking on a trip, or any combination thereof. Said subsequent customer activity can include at least one of making a purchase using said customer account, joining said rewards program, embarking on a trip, maintaining a balance in said customer account, engaging in a predetermined number of transactions with respect to said customer account, maintaining said customer account in good standing for a predetermined time, or any combination thereof. Enhancing said saved reward can include at least one of increasing said reward by a percentage of said reward, providing said customer with goods, providing said customer with services, or any combination thereof.

Some embodiments include a system for operating a rewards program including a reward processing component configured to award an initial reward to a customer based on customer activity with respect to a customer account, said initial reward including initial terms of said initial reward; a reward storage component configured to save said initial reward; an enhanced reward processing component configured to enhance said saved reward based at least in part on subsequent customer activity with respect to said customer account; and a reward issuing component configured to distribute said enhanced reward to said customer, wherein enhancing said saved reward includes improving said saved reward beyond said initial terms of said initial reward.

Some embodiments include a method of operating a rewards program including awarding an initial reward to a customer based on customer activity with respect to a customer account, said initial reward including initial terms of said initial reward; saving said initial reward; enhancing said saved reward based at least in part on subsequent customer activity with respect to said customer account; and distributing said enhanced reward to said customer in real time, wherein enhancing said saved reward includes improving said saved reward beyond said initial terms of said initial reward.

In other embodiments, reward amounts may be calculated, reported and/or redeemed to or by a cardholder or issuing financial institution in real-time, such as via the Internet or other communications network. Additionally, rewards may be calculated on a tiered structure, a date range, and/or a multiplier of transaction amounts. Rewards may be calculated differently depending on the merchant at which a purchase occurred, on the type of merchant at which a purchase occurred, on the type of merchandise or service purchased, or based on other criteria. Alternatively, the rewards may be calculated the same regardless of the merchant visited or merchandise purchased. Additionally, although the reward is described herein as typically constituting cash back, or statement credit, it should be understood that other rewards are possible, such as points or credit that can be redeemed for other goods or services, as appreciated by persons of ordinary skill in the art.

### BRIEF DESCRIPTION OF THE DRAWINGS

For a more complete understanding of example embodiments of the present invention and its advantages, reference is now made to the following description, taken in conjunction with the accompanying drawings, in which:

FIG. 1 is a flowchart of an example procedure according to an embodiment of the present invention.

FIG. 2 is a flowchart of an example procedure according to another embodiment of the present invention.

FIG. 3 is a block diagram of example components according to an embodiment of the present invention.

FIG. 4 is a flowchart of an example procedure according to yet another embodiment of the present invention.

FIG. 5 is a representation of example transaction data in accordance with an embodiment of the present invention.

FIG. 6 is a representation of an example data structure in accordance with an embodiment of the present invention.

FIG. 7 is a flowchart of an example procedure according to an embodiment of the present invention.

FIG. 8 is a flowchart of an example procedure according to another embodiment of the present invention.

FIG. 9 is a block diagram of example components according to an embodiment of the present invention.

### DETAILED DESCRIPTION

Generally, systems and methods encourage customer loyalty by providing an enhanced rewards program. A customer with an account with an account provider may receive a reward (e.g., cash back) for activity with respect to the account. To encourage loyalty, the customer may be asked whether they wish to save the reward, and the saved reward may be enhanced based at least in part on subsequent activity with respect to the account (e.g., maintaining the account in good standing for a predetermined time). The customer may be awarded the enhanced reward once the conditions of the subsequent activity have been satisfied. In one example embodiment, a customer may receive cash back as a reward for a purchase. As an incentive to remain with the financial institution, the customer may decline to redeem the cash back, and the cash back amount may increase by a multiple after a predetermined time.

In other embodiments, reward amounts may be calculated, reported and/or redeemed to or by a cardholder or issuing financial institution in real time, such as via the Internet or other communications network. Additionally, rewards may be calculated on a tiered structure, a date range, and/or a multiplier of transaction amounts. Rewards may be calculated differently depending on the merchant at which a purchase occurred, on the type of merchant at which a purchase occurred, on the type of merchandise or service purchased, or based on other criteria. Alternatively, the rewards may be calculated the same regardless of the merchant visited or merchandise purchased. Additionally, although the reward is described herein as typically constituting cash back, or statement credit, it should be understood that other rewards are possible, such as points or credit that can be redeemed for other goods or services, as appreciated by persons of ordinary skill in the art.

Providing incentives to the customer in this way encourages customer loyalty because the customer is enticed to engage in the subsequent activity to receive the enhanced reward.

In one embodiment, the reward is distributed to the customer in real time, for example, over the internet or other appropriate network. An account provider at which the customer has opened an account may issue an initial reward to the customer (e.g., an amount of cash back). The initial reward may be given in connection with customer activity (e.g., a percentage cash back for each transaction made using the account of the account provider). The customer may engage in activity that qualifies the customer for an enhanced reward. For example, the qualifying activity may include saving the initial reward (e.g., not redeeming the initial reward) and engaging in other activities (e.g., maintaining the account in good standing for a particular period of time). The rules of the program may entitle the customer to an enhancement of the reward (e.g., the saved reward is increased by an amount for each month that the customer engages in the qualifying activity). The reward may be automatically provided to the customer (e.g., by depositing the additional amount in the customer's checking account). The customer's bank where the checking account is located may be different than the account provider, and the enhanced reward may be provided over an appropriate network, such as an electronic funds transfer (EFT) network. In this way, the customer may be able to realize an immediate reward for engaging in qualifying activity and may be encouraged to maintain a relationship with the account provider. In other embodiments, real-time statements may be provided to the customer. Transaction information may be stored in a database, and a daily script may be executed that updates a status file with the user's enhanced rewards. The customer's status may be provided to the customer upon request (e.g., over the world wide web).

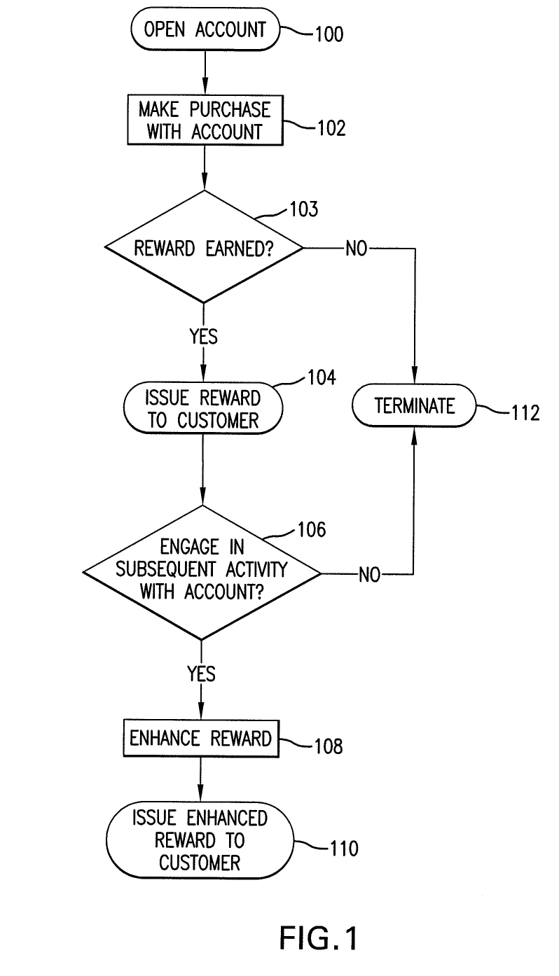

FIG. 1 is an example procedure according to an embodiment of the present invention. A customer may open an account (block 100) with an account provider associated with a rewards program. The customer may perform an action with respect to the account, for example making a purchase with funds from the account (block 102). If the purchase is a qualifying reward activity (block 103), an initial reward may be awarded to the customer (block 104). Otherwise, no reward may be provided (block 112). The rewards program may be structured such that subsequent activity with respect to the account may enhance the initial reward that the customer has already received. If the customer engages in the subsequent activity (block 106), then the initial reward may be enhanced (block 108) and the enhanced reward may be issued to the customer (block 110). If no such subsequent activity has taken place, then the enhanced reward may be withheld from the customer (block 112).

The account provider may include any organization associated with the user account. Examples of account providers may include payment card providers (e.g., credit card, debit card, and stored value card providers), frequent use providers (e.g., airline frequent traveler and frequent vendor purchase providers). Stored value cards may include cards in which an amount is deposited onto the card and purchases made with the card deduct funds from the amount. In some example embodiments, the account providers may issue rewards to their customers to encourage customer loyalty.

In practice, the account provider may issue the rewards itself or may be associated with another organization that issues the rewards. For example, the account provider may include a payment card entity. The payment card entity may issue the rewards itself, for example, in the form of cash back, statement credit, money deposited into another account (e.g., a college savings account). In another example embodiment, an outside rewards organization, other than the account provider, may issue the rewards, for example, an airline miles program, car purchase program, hotel frequent stay program. For example, to create an incentive for a credit card customer to charge a particular amount of purchases to the credit card, the credit card provider may offer the customer airline miles issued by an outside organization, for example, the airline itself. In this example embodiment, the outside rewards organization may manage the issuance and distribution of rewards to the customer and may issue rewards at the instruction of the account provider.

In another example embodiment, the initial reward and enhanced reward may be provided by different organizations. The account provider may provide an initial reward while the outside rewards organization may provide an enhanced reward and vice versa. Furthermore, both the initial reward and the enhanced reward may be provided by outside rewards organizations other than the account provider. In one example embodiment, the account provider may provide an initial reward to the customer, and the outside rewards organization may provide the enhanced reward. For example, the account provider may be a payment card provider, and upon the customer's first purchase, the payment card provider may issue the customer an amount of cash back. Once the customer has fulfilled the requirements of the subsequent activity, the outside rewards organization (e.g., an airline frequent traveler program), may provide the customer with an enhanced reward (e.g., a discount on travel). In another example embodiment, the initial reward may include the discount travel reward from the outside rewards organization, and the enhanced reward may include discounts on travel insurance from another outside rewards organization.

The initial reward and enhanced reward may be the same type of reward or may be different types of rewards. For example, the initial reward may include cash back, and the enhanced reward may be an additional amount added to the cash back. In another example embodiment, the initial reward may include cash back, and the enhanced reward may include another type of reward, for example, a discount on travel, merchandise, or other goods or services.

Rewards-qualifying activity with respect to the user account may vary according to the rules and requirements of the particular rewards program. Qualifying activity may include actions associated with the user account or may include unrelated actions. For example, user account activities associated with the user account may include opening the user account, purchasing goods or services with account funds, charging funds to the account, maintaining the account in good standing, keeping the account open for a period of time, maintaining a balance in the account, etc. Unrelated actions may include taking actions with respect to other organizations or actions with the account provider that do not impact the user account. For example, activities with outside organizations may include opening or maintaining an account with the outside organization, purchasing goods or services through the outside organization. For example, actions unrelated to the user account but associated with the account provider may include opening a second account with the account provider.

The type of rewards qualifying activity may also vary with respect to the rules and requirements of the particular rewards program. Example activities that may qualify for either the initial or enhanced rewards include opening an account, maintaining the account in good standing, purchasing goods, services or particular types of goods or services, spending a particular monetary amount, completing qualifying travel (e.g., cruises or airline flights), making purchases from particular vendors or types of vendors, making a particular number of purchases or a particular total value of purchases, combinations of the foregoing, etc. In practice, many other qualifying rewards activities may be possible. The qualifying activity for the initial and enhanced rewards may be the same activity or may be different activities. For example, an initial reward may be provided to a customer upon account sign-up, while an enhanced reward may be provided if the customer purchases a predetermined amount of goods and/or services using the account in the first year.

In one example embodiment, the enhanced reward may depend on the initial reward. For example, a multiplier may be applied to the initial reward to enhance the initial reward. In one example embodiment, an account provider may issue a reward to a customer. The rewards program rules may specify that the reward is to be doubled if the customer remains with the account provider for thirty-six months. As this example demonstrates, the enhanced reward may depend on the initial reward. In another example embodiment, the initial reward may include cash back. The rewards program rules may give the customer the option to redeem the cash back for twice the value of the cash back with a partner travel organization. As this example demonstrates, the enhanced reward may depend on the initial reward even though the enhanced reward may be issued by an outside organization.

Enhancing the reward may involve providing a greater reward to the customer. A greater reward may include any reward which a customer may find to be more valuable than the initial reward. For example, the customer may be provided with more funds, goods, services, discounts, or the like as an enhanced reward. As this example demonstrates, “more” of the reward may be considered “greater.” In another example embodiment, “less” may be considered greater. For example, the initial reward may include a mortgage product that initially includes mortgage points. An enhanced reward may reduce the number of points, thereby providing the customer with a greater benefit.

Enhancing a reward may include improving the reward beyond the terms of the initial reward. For example, an initial reward may include a certain growth rate, and enhancing the reward may increase the growth rate. In one example embodiment, the reward may include cash back that grows at five percent interest so long as the customer remains with the account provider. Enhancing the reward may increase the percentage growth, for example, to 10 percent for qualifying, subsequent activity, for example, remaining with the account provider for three years or purchasing a certain amount of goods through the account provider. In another example embodiment, the reward may include a promise of 10,000 bonus airline miles if the customer account is kept in good standing for a year. The bonus miles may be increased to 30,000 if the customer purchases $10,000 or more using the account provider.

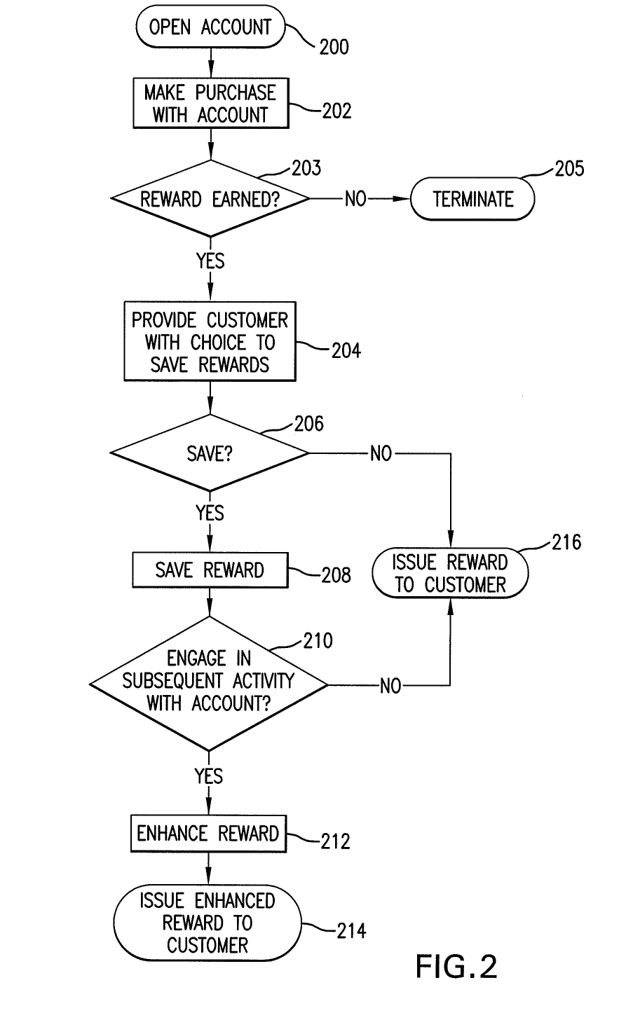

In one example embodiment, the initial reward may not be issued to the customer immediately but may be saved. The rules of the program may specify that saved rewards may be subject to enhancement based at least in part on qualifying, subsequent activity, as shown in FIG. 2.

FIG. 2 is an example procedure according to another embodiment of the present invention. A customer may open an account (block 200) with an account provider associated with a rewards program. The customer may perform an action with respect to the account, for example making a purchase with funds from the account (block 202). If the activity is a qualifying rewards activity (block 203), the customer may be presented with a choice of whether to save the initial reward or not (blocks 204 and 206). If the activity is not qualifying activity, no reward may be provided (block 205). The program rules may confer an enhanced reward on the customer where the initial reward is saved and the customer engages in qualifying subsequent activity. If the customer chooses to save the initial reward, the account provider may save the initial reward (block 208). If the customer engages in subsequent activity that is qualifying activity for the enhanced reward (block 210), then the saved reward may be enhanced (block 212) and the enhanced reward may be provided to the customer (block 214). If the customer fails to engage in the qualifying, subsequent activity or chooses not to save the initial reward, the initial reward may be issued to the customer (block 216).

The choice to save initial rewards may be presented to the customer in various ways according to the requirements of the particular rewards program. The initial reward may be automatically saved, automatically issued to the customer, or the customer may be required to decide whether the initial reward is to be saved or not. For example, if the initial reward is automatically saved, the customer may be provided with a statement of the initial reward and a balance showing all of the rewards saved up to the present. In another example embodiment, the initial reward may automatically be issued to the customer unless the customer elects to save the initial reward. For example, the customer may be presented with a notification of the initial reward and a form to elect to save the initial reward (e.g., by regular postal mail, electronic mail, or on the account provider's web site). If the customer chooses not to receive the initial reward immediately, the initial reward may be saved. The customer may likewise be presented with updates as to the balance of rewards. In yet another example embodiment, the form may ask the customer to elect whether the initial reward is to be issued or saved. The account provider may hold the initial reward in abeyance until the customer elects or until such time that the account provider's own constraints require it to elect a choice for the customer (e.g., at the end of the accounting fiscal year).

In one example embodiment, a portion of the initial reward may be saved, and a portion may be issued to the customer. As with the foregoing, the customer may elect the portion to be saved, or a preselected portion may be automatically saved each time an initial reward is earned.

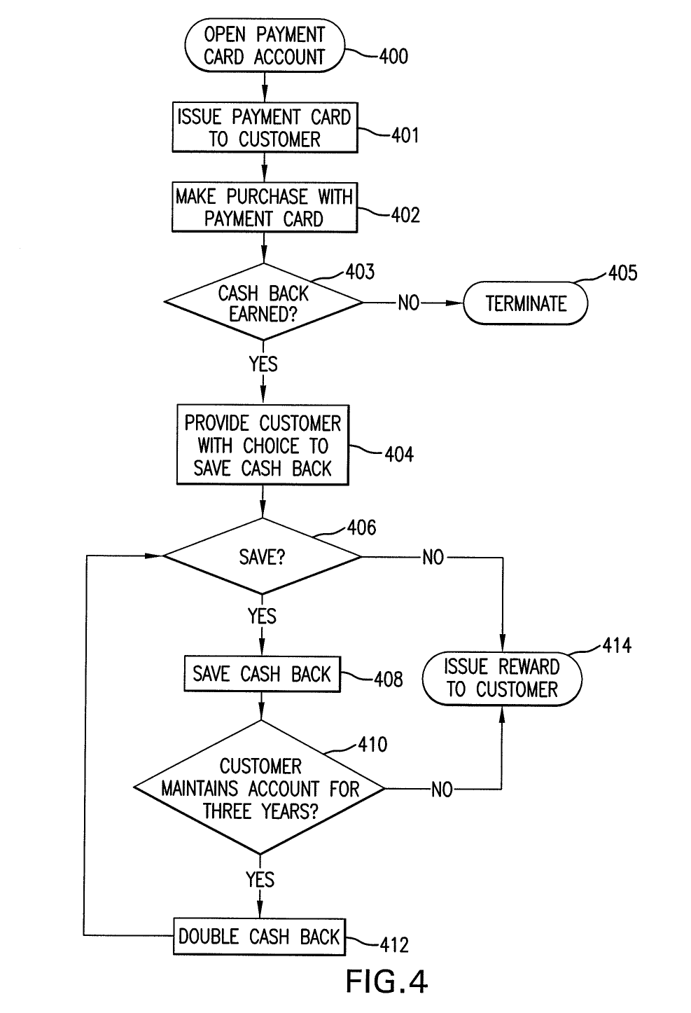

FIG. 4 is an example procedure according to yet another embodiment of the present invention. A customer may initiate a relationship with a payment card provider, for example, a credit card provider, by opening an account (block 400). Once the customer's credentials have been verified, the customer may be issued a payment card (block 401). Advertising associated with the card may have included a rewards program in which the customer's rewards may be enhanced based on how long the customer maintains an account with the payment card provider after the rewards have been earned. In this way, the payment card provider may encourage customer loyalty.

The customer may be provided with an amount of cash back for purchases made with the payment card. For example, the customer may receive three percent cash back for purchases from certain vendors and one percent cash back for purchases from all other venders. The customer may make a purchase with the payment card (block 402). Information related to the charge may be transmitted back to the payment card provider. From this information, the payment card provider may determine whether the purchase qualifies for cash back (block 403), and the amount of cash back earned. If the charge was not a qualifying charge, then the customer may not be provided with any cash back (block 405). If the charge qualifies, then the payment card provider may ask the customer whether the cash back should be issued or saved (blocks 404 and 406). If the customer desires the cash back immediately, then the cash back may be issued (block 414). The cash back may be in various forms, including statement credit, a check, or the like.

If the customer elects to save the cash back, the payment card provider may store the cash back amount (block 408). The stored cash back amount may be associated with a time stamp indicating when the cash back amount was earned. Program rules may indicate that saved cash back amounts may be doubled if the customer maintains the payment card account for three years following the time that the cash back was awarded. The payment card provider may compare the time stamp associated with the cash back reward to see if three years have elapsed. If three years have elapsed and the customer has maintained the payment card account (block 410), the cash back amount may be doubled (block 412). For example, a 1% earned cash back reward with a three-year 100% multiplier would effectively amount to a 26% annual return on the original earned reward. The significance of this reward may encourage customer loyalty.

The customer may be presented with the choice of whether they wish to save the rewards (block 406). If not, then the cash back may be issued to the customer. If so, the cash back may again be associated with the time stamp at the date of the election, and the payment card provider may later check to see whether the customer has maintained the payment card account for another three years.

In one example embodiment, the account provider organization may be distinct from the rewards organization. Information required for reward determination may be forwarded to the rewards organization in addition to the charge information being forwarded to the account provider. For example, the rewards information for rewards determination may include a customer identifier, the amount of the purchase, the vendor and vendor type from which the reward activity took place, and the date of the activity. Where security may be a concern, information for example, the customer's account number and other information specific to the charge may be withheld from the rewards organization to protect the customer's identity.

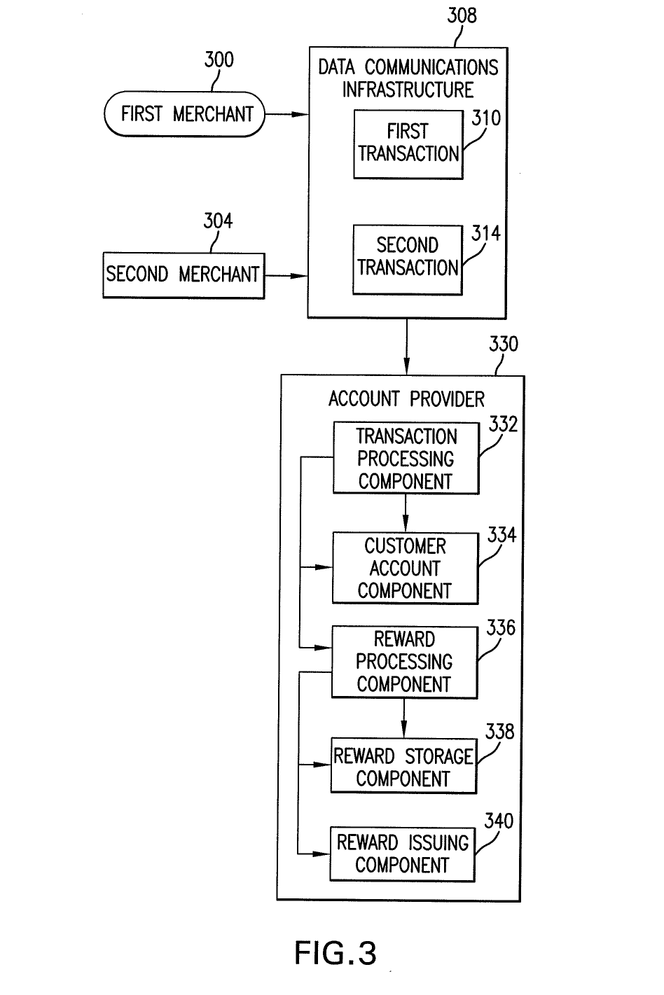

FIG. 3 is a block diagram of example components according to an embodiment of the present invention including a first merchant 300 and a second merchant 304 in communication with an account provider 330 over a data communications infrastructure 308. The data communications infrastructure 308 may permit the merchants to communicate transactional information to the account provider 330. For example, data communications infrastructure 308 may include shared infrastructures for example, local or wide area networks or may include private communications channels, for example, dedicated subscriber lines or dial up connections.

An example rule of the rewards program may specify that a reward from a first purchase may be enhanced if the customer makes a second purchase of more than $5,000 within the first three months after the first purchase. Any points balance existing three months earlier may be doubled. It should be noted that the example rule is only illustrative and that other rules may be used according to the principles herein.

A customer may have an account with an account provider entitling the customer to the benefit of the initial reward and enhanced reward for qualifying activity. For example, account provider 330 may be a discount card provider. The customer may be entitled to receive discounts at participating merchants as well as to earn points with the discount card provider based on the purchases made.

The account provider 330's site may be operated by a computing infrastructure including a transaction processing component 332, customer account component 334, reward processing component 336, reward storage component 338, and reward issuing component 340. Account provider 330 may include a single computing platform or may include a number of computing platforms connected over a data communications infrastructure (e.g., a local area network, wide area network, or private network). Each component may be associated with data storage for storing the various segments of data needed. Data storage may be accomplished in various ways in accordance with the requirements and design of account provider 330's site, for example in databases, flat text files, in programming data structures, on magnetic disks, removable media, and the like.

The information for the customer's account may be stored in customer account component 334. In one example embodiment, customer account component 334 may include a database of customers and related data, for example, keyed by unique customer identifiers. Information that may be stored for a customer may include name, address, card number, recent transactions, spending limits, and the like.

A customer may make a first purchase using the discount card at first merchant 300. First merchant 300 may gather transaction information for the purchase and forward a first transaction 310 to account provider 330 over data communications infrastructure 308. The transaction information contained in first transaction 310 may include information to identify the customer, vendor, and the transaction, for example, the discount card number, customer name, date of the transaction. If the account provider 330 also manages the funds necessary for the transaction, then additional information, for example, the customer's account number, signature, and other identifying and verifying information may be included in the first transaction 310.

The transaction processing component 332 may receive the first transaction 310. Transaction processing component 332 may determine whether the customer associated with first transaction 310 participates in the rewards program. In another example embodiment, where the account provider also manages the funds for the account, transaction processing component 332 may also execute the necessary operations to complete payment for the transaction.

If the customer participates in the rewards program, transaction processing component 332 may send the transaction information to reward processing component 336. Reward, processing component 336 may determine, based on rewards program rules, how much of a reward the purchase warrants. For example, the rules may specify that a base of 1 point for every dollar may be rewarded for any purchase, regardless of the merchant. Another rule may specify that merchants of the type to which first merchant 300 belongs may receive three points for every dollar spent. Reward processing component 332 may determine, based on the merchant's identifier, purchase amount, and any other relevant information, the size of the reward.

Reward processing component 336 may also inquire with the customer whether the customer wishes to save the reward or redeem the reward. Reward processing component 336 may include facilities to communicate with the customer, for example by printed mail, fax, electronic mail, electronic messaging services, interne sites. Reward processing component 336 may look up the customer's contact information in customer account component 334 using the customer identifier associated with first transaction 310.

If the customer elects to save the reward points, reward processing component 336 may send the information associated with first transaction 310 as well as the amount of the reward to reward storage component 338. Reward storage component 338 may include data storage necessary to store the reward. For example, the stored reward may include the amount of the reward, the timestamp indicating when the qualifying activity associated with the reward was taken, and customer identifying information.

If the customer elects to redeem the reward, the information associated with first transaction 310 may be sent to reward issuing component 340. Reward issuing component 340 may issue the reward to the customer. For example, the customer may be permitted to redeem the points for merchandise and services. The customer may also be permitted to store the points in a points account which may not be associated with an enhanced reward. For example, one field of customer account component 334 may include a point balance, and the points may be stored therein.

The customer may make a second purchase with second merchant 304. Second merchant 304 may gather the transaction information and may forward a second transaction 314 to transaction processing component 332 of account provider 330 over data communications infrastructure 308. Transaction processing component 332 may determine that second transaction 314 qualifies for a reward and may send the information associated with second transaction 314 to reward processing component 336. Reward processing component 336 may determine whether the reward is an initial reward or qualifies the customer for an enhanced reward. To determine whether the reward qualifies the customer for an enhanced reward, reward processing component 336 may determine whether the second transaction is for an amount greater than $5,000. If so, reward processing component 336 may search reward storage component 338 for all unenhanced rewards having a date on or earlier than three months prior to the date associated with second transaction 314. Reward processing component 336 may total these unenhanced rewards. The resulting amount may be the balance of reward points that is three or more months old. Reward processing component 336 may double the points as the enhancement and may ask the customer whether they wish to save the enhanced reward for further, possible enhancement or redeem the reward. If the enhanced reward is to be saved for further, possible enhancement, then reward storage component 338 may store the enhanced reward with the enhanced amount with the date on which the reward was enhanced.

In one example embodiment, awarding the initial reward and the enhanced reward may be accomplished by separate components, for example, an initial reward processing component and an enhanced reward processing component. The initial reward processing component may award the initial rewards while the enhanced reward processing component may award the enhanced rewards. The specific division between the initial reward processing component and the enhanced reward processing component may vary according to the requirements of the system. For example, all reward qualifying transactions may be processed through either the initial or enhanced reward processing components or may be done through both components. In another example embodiment, transaction processing component 332 may determine whether an initial reward or enhanced reward is to be awarded and send the transaction information to the corresponding component to be awarded.

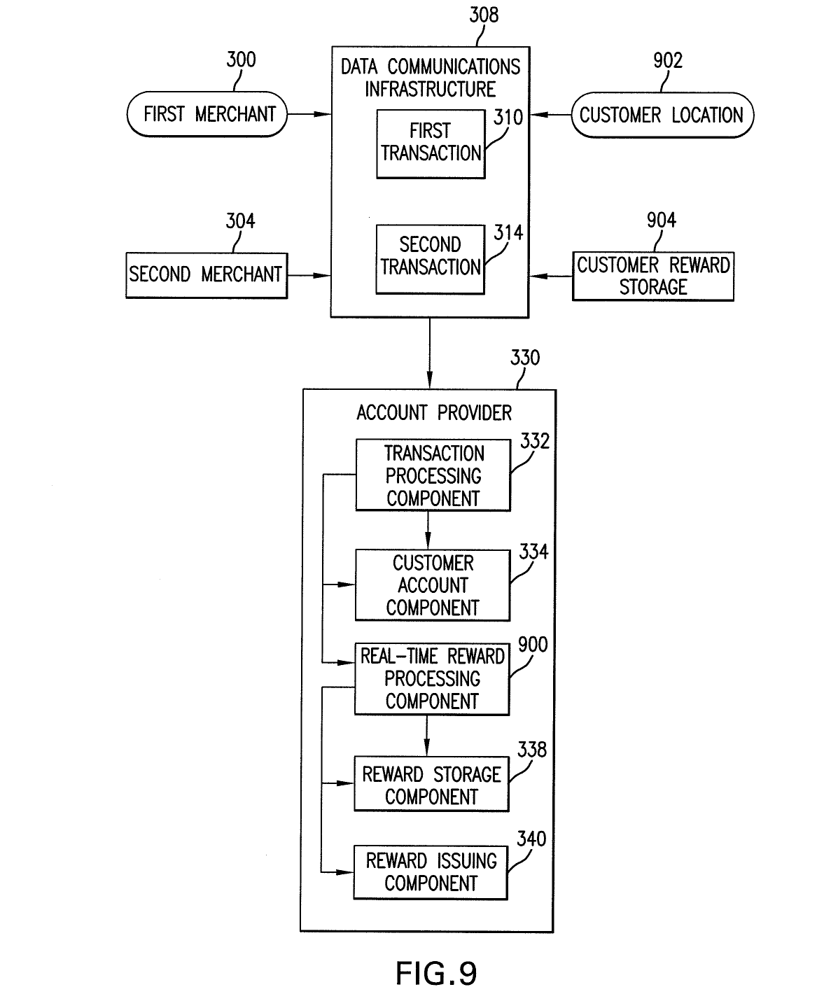

In another embodiment, processing of the rewards and enhanced rewards may be performed in real-time and may be reported and/or awarded to the customer in real-time. FIG. 9 is a block diagram of example components according to an embodiment of the present invention. FIG. 9 includes some components in common with FIG. 3. The differences are described. A customer location 902 and a customer reward storage 904 (e.g., a customer bank) are connected to data communications infrastructure 308. Customer location 902 may include customer equipment (e.g., a customer computer) capable of communicating with account provider 330. A customer at customer location 902 may wish to obtain status of the customer's rewards. The customer causes the customer equipment at customer location 902 to send a status request message to account provider 330. Account provider 330 may include facilities to satisfy the status request, for example, a web server capable of interpreting and responding to the status request. A Real-time processing component 900 exists at account provider 330 to provide the most up to date reward information. For example, after each transaction processed by transaction processing component 332, real-time reward processing component 900 may update reward storage component 338 with any rewards that are due to the customer. In this way, reward storage component 338 contains the most up to date reward information.

Upon receiving the status request, account provider 330 may send a request to reward storage component 338 to obtain the customer's latest reward information. The account provider may package the information in a status message that is sent back to the customer at customer location 902 over data communications infrastructure 308. In this way, the customer is provided with real-time status of his/her rewards, avoiding the need to wait for a statement to be sent out.

In another embodiment, real-time status may include reporting the status to the customer without the need for a status request. For example, the customer location 902 may include a cellular telephone capable of receiving text messages or other incoming communications. As soon as a reward is obtained, real-time reward processing component 900 may send a status message to the customer with information about the rewards. In this way, the customer is kept up to date with the latest reward information in real-time.

In another embodiment, the actual rewards may be issued to the customer in real-time. The reward provided to the customer, which includes both an initial reward and the enhanced reward, may be cash back. In one embodiment, issuing the reward by reward issuing component 340 includes depositing the reward in the customer's account at customer reward storage 904 (e.g., the customer's bank). This avoids the need for the customer to wait a certain period of time before the reward is realized and helps to encourage customer loyalty.

In another embodiment, the customer reward storage may function to save the reward, for example, when the customer wishes to obtain an enhanced reward. The customer reward storage may exist at a remote location (as shown in FIG. 9) or may exist as part of account provider 330. In either case, the reward is determined in real-time by real-time reward processing component 900 and sent to customer reward storage 904 where it is saved. In another embodiment, the enhanced reward, when it is achieved, may be automatically remitted to the customer, for example, by depositing funds into the customer's bank account. As described above, the reward status may be reported to the customer in real-time in response to a status request or sent to the customer automatically.

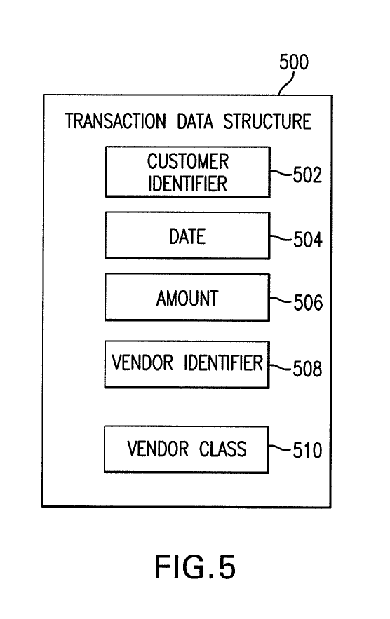

FIG. 5 is example transaction data in accordance with an embodiment of the present invention. An example transaction 500 sent from a merchant to an account provider may include a customer identifier 502 that may uniquely identify the customer to the account provider, a date 504 of the transaction, an amount 506 of the transaction (e.g., a monetary amount), a vendor identifier 508 to identify the merchant, and a vendor class 510. The transaction data may be stored and used, for example, to determine whether the customer is entitled to an enhanced reward.

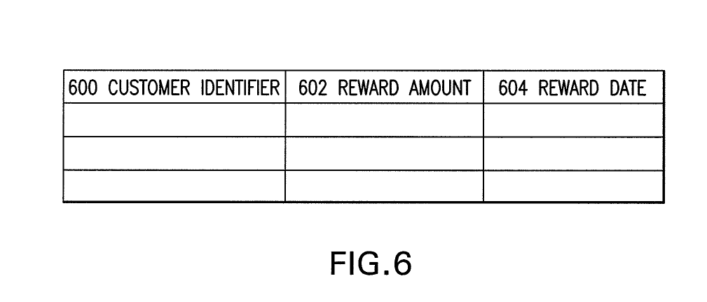

FIG. 6 is an example data structure in accordance with an embodiment of the present invention. The reward storage component may store rewards information for unenhanced rewards in the shown table, including customer identifier 600, reward amount 602, and reward date 606. The reward date may be the date on which the reward was given or enhanced. In some embodiments, data stored in the data structure may be stored in a database or other storage media. The data may be retrieved for processing and for providing the reward to the customer.

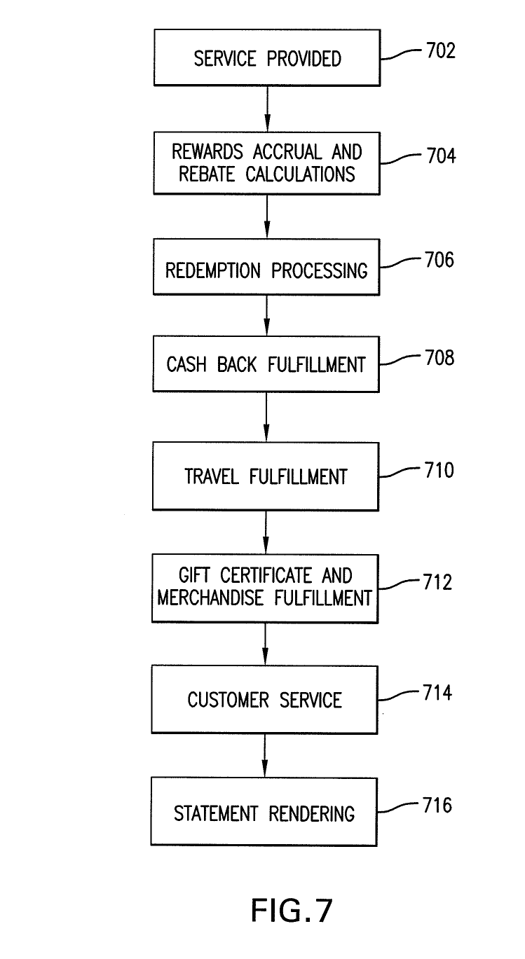

FIG. 7 depicts a procedure for a typical reward provider to award and report rewards to a customer. A service (e.g., extending credit) is provided by a service provider (block 702). Rules of the reward provider may include awarding a reward based on some customer activity (e.g., spending a certain amount). Rewards and rebates may be calculated by the reward provider (block 704), and the reward may be processed (block 706). Typically, rewards are provided to the customer after a certain amount of time has passed. For example, many airline miles cards state that airline miles will appear a certain amount of time after the qualifying activity (e.g., after six to eight weeks).

The reward is then provided to the customer (blocks 708-712). Some time after the reward is processed, the reward is reported to the customer (e.g., on a statement) (blocks 714 and 716).

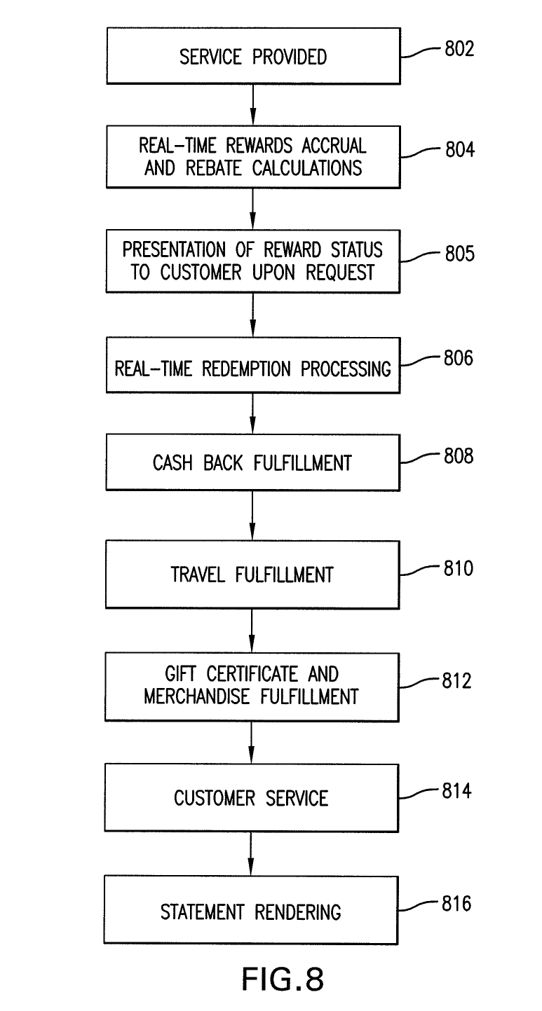

FIG. 8 depicts an example procedure according to an embodiment of the present invention. A service is provided to the customer (block 802). Rewards and/or rebates are then calculated in real time (block 804). For example, a reward may include a percentage cash back based on the amount of a purchase. As soon as the transaction is processed by the account provider, the reward provider may determine whether and how much of a reward is due.

In one embodiment, the customer may request a rewards status, and the reward provider may provide the most up to date reward status (block 805). The reward status may include the reward determined in block 804 and thus is a real-time reward status. The reward may be provided to the customer in real-time, for example, in response to a reward request (blocks 806-812). For example, the reward provider may be in communication with the customer's bank. A cash back reward may automatically be deposited into the customer's bank account. In this way, the customer need not wait for either the reporting of the accrued reward or the receipt of the reward. This feature may encourage customer loyalty and customer satisfaction.

The appropriate reward fulfillment mechanism may be used according to the type of reward. For example, a gift certificate reward may be provided at block 812. The reward is then reported to the customer (e.g., on a statement) (blocks 714 and 716), for example, as part of a monthly summary.

In some embodiments, an account provider has the capability of householding rewards/rebates across product lines. For example, a customer may receive rewards for activity for activity on various accounts with the account provider (e.g., a credit card, bank account, mortgage, etc.). In some embodiments, statements and reward requests may be made at an account provider from the account provider's website. In some embodiments, the rewards may be awarded in a tiered structure. For example, qualifying activity can be tiered. A certain percentage cash back can be awarded for some activities (e.g., one percent cash back for purchases at general venders). A higher percentage may be awarded for cash back at specific venders (e.g., two percent cash back from purchases with venders with who the account provider has a special relationship). The awards may be tiered based on merchant codes grouped into tiers.

In some embodiments, the bonus or reward may be a multiplier of a transaction amount, based on the number of transactions in a given time period, and the like.

The foregoing merely illustrates the principles of the present invention. Various modifications and alterations to the described embodiments will be apparent to those skilled in the art in view of the teachings herein. It will thus be appreciated that those skilled in the art will be able to devise numerous techniques which, although not explicitly described herein, embody the principles of the invention and are thus within the spirit and scope of the invention.

1. A method of operating a rewards program, comprising:
awarding an initial reward to a customer based on customer activity with respect to a customer account, said initial reward including initial terms of said initial reward;
saving said initial reward;
enhancing said saved reward based at least in part on subsequent customer activity with respect to said customer account; and
distributing said enhanced reward to said customer,
wherein enhancing said saved reward includes improving said saved reward beyond said initial terms of said initial reward.

2. The method of claim 1, wherein said initial reward includes cash back, said subsequent customer activity includes maintaining said customer account in good standing for a predetermined time, and enhancing said saved reward includes increasing said cash back by a percentage of said cash back.

3. The method of claim 1, wherein said initial reward includes at least one of reward points, cash back, statement credit, an amount redeemable for other goods or services, goods, services, or any combination thereof.

4. The method of claim 1, wherein said customer account is associated with a payment card account.

5. The method of claim 4, wherein said payment card is a credit card, debit card, or stored value card.

6. The method of claim 1, wherein said rewards program is associated with an airline frequent flier program.

7. The method of claim 1, wherein said customer activity includes at least one of making a purchase using said customer account, joining said rewards program, embarking on a trip, or any combination thereof.

8. The method of claim 1, wherein said subsequent customer activity includes at least one of making a purchase using said customer account, joining said rewards program, embarking on a trip, maintaining a balance in said customer account, engaging in a predetermined number of transactions with respect to said customer account, maintaining said customer account in good standing for a predetermined time, or any combination thereof.

9. The method of claim 1, wherein enhancing said saved reward includes at least one of increasing said reward by a percentage of said reward, providing said customer with goods, providing said customer with services, or any combination thereof.

10. A system for operating a rewards program, comprising:
a reward processing component configured to award an initial reward to a customer based on customer activity with respect to a customer account, said initial reward including initial terms of said initial reward;
a reward storage component configured to save said initial reward;
an enhanced reward processing component configured to enhance said saved reward based at least in part on subsequent customer activity with respect to said customer account; and
a reward issuing component configured to distribute said enhanced reward to said customer,
wherein enhancing said saved reward includes improving said saved reward beyond said initial terms of said initial reward.

11. The system of claim 10, wherein said initial reward includes cash back, said subsequent customer activity includes maintaining said customer account in good standing for a predetermined time, and enhancing said saved reward includes increasing said cash back by a percentage of said cash back.

12. The system of claim 10, wherein said initial reward includes at least one of reward points, cash back, statement credit, an amount redeemable for other goods or services, goods, services, or any combination thereof.

13. The system of claim 10, wherein said customer account is associated with a payment card account.

14. The system of claim 13, wherein said payment card is a credit card, debit card, or stored value card.

15. The system of claim 10, wherein said rewards program is associated with an airline frequent flier program.

16. The system of claim 10, wherein said customer activity includes at least one of making a purchase using said customer account, joining said rewards program, embarking on a trip, or any combination thereof.

17. The system of claim 10, wherein said subsequent customer activity includes at least one of making a purchase using said customer account, joining said rewards program, embarking on a trip, maintaining a balance in said customer account, engaging in a predetermined number of transactions with respect to said customer account, maintaining said customer account in good standing for a predetermined time, or any combination thereof.

18. The system of claim 10, wherein enhancing said reward includes at least one of increasing said reward by a percentage of said reward, providing said customer with goods, providing said customer with services, or any combination thereof.

19. A method of operating a rewards program, comprising:
awarding an initial reward to a customer based on customer activity with respect to a customer account, said initial reward including initial terms of said initial reward;
saving said initial reward;
enhancing said saved reward based at least in part on subsequent customer activity with respect to said customer account; and
distributing said enhanced reward to said customer in real time,
wherein enhancing said saved reward includes improving said saved reward beyond said initial terms of said initial reward.
